(19) United States
(12) Patent Application Publication
(10) Pub. No.: US 2011/0096991 A1
(43) Pub. Date: Apr. 28, 2011

(54) SYSTEM AND METHOD FOR PROCESSING IMAGES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/692,511

(22) Filed: Jan. 22, 2010

(30) Foreign Application Priority Data
Oct. 23, 2009 (CN) 200910308749.1

(51) Int. Cl. G06K 9/34

(52) U.S. Cl. 382/173

(57) ABSTRACT

A system and method for processing images obtains an image from a storage device, locates a specified object in the image. The system and method further calculates a smallest rectangle framing the specified object, performs a masking operation on the smallest rectangle, and stores the processed image in the storage device.

### BACKGROUND

1. Technical Field

Embodiments of the present disclosure relate to image processing technology, and particularly to a system and a method for processing images using an object locating technology.

2. Description of Related Art

Currently, some specified objects (e.g., a face or a license plate) in an image are masked by an operator in order to protect user privacy, so that the specified objects cannot be clearly seen and identified by other people. However, if a large quantity of images need to be processed, performing masking operations in each image becomes a very time-consuming job. Therefore, a better method for processing images is desired.

### BRIEF DESCRIPTION OF THE DRAWINGS

FIG. 1 is a block diagram of one embodiment of a computer comprising an image processing system for processing images.

FIG. 2A-2C are schematic diagrams of one embodiment of performing a masking operation on a specified object in an image.

FIG. 3 is a flowchart of one embodiment of a method for processing images.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

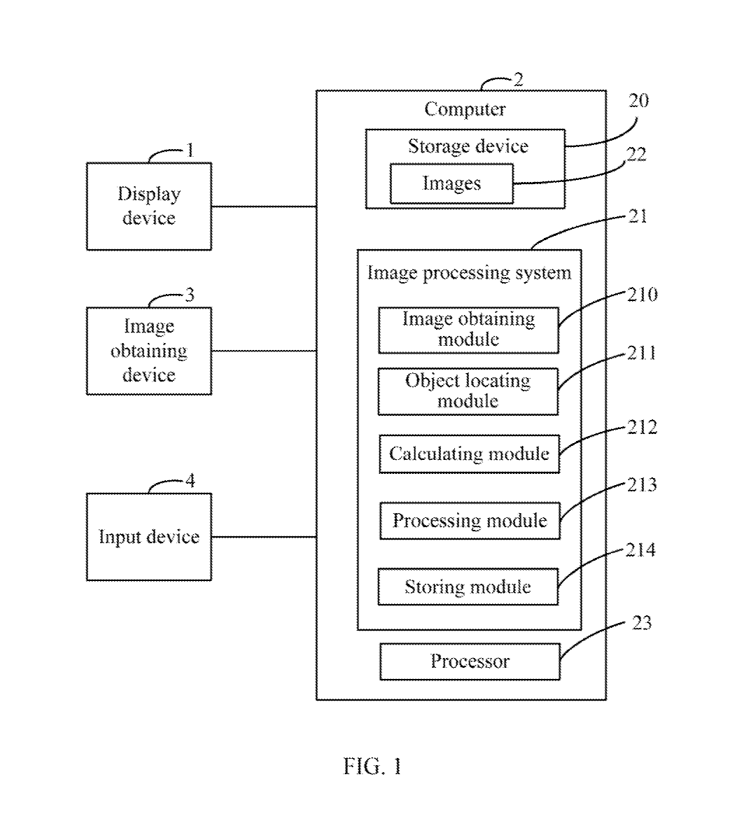

FIG. 1 is a block diagram of one embodiment of a computer 2 comprising an image processing system 21. In one embodiment, the image processing system 21 may be used to automatically perform a masking operation on a specified object in an image. A detailed description will be given in the following paragraphs.

In one embodiment, the computer 2 is electronically connected to a display device 1, an image obtaining device 3, and an input device 4. Depending on the embodiment, the display device 1 may be a liquid crystal display (LCD) or a cathode ray tube (CRT) display, for example.

The computer 2 further includes a storage device 20 for storing information, such as images 22 captured by the image obtaining device 3 or inputted from an external electronic device. In one embodiment, the image obtaining device 3 may be an Internet Protocol (IP) camera, and the external electronic device may be a universal serial bus (USB) flash disk.

The input device 4 may be used to manually select images displayed on the display device 1. In one embodiment, the input device 4 may be a keyboard.

In one embodiment, the image processing system 21 includes an image obtaining module 210, an object locating module 211, a calculating module 212, a processing module 213, and a storing module 214. In one embodiment, the modules 210-214 comprise one or more computerized instructions that are stored in the storage device 20. A processor 23 of the computer 2 executes the computerized instructions to implement one or more operations of the computer 2.

The image obtaining module 210 obtains an image from the storage device 20. In one embodiment, the images 22 stored in the storage device 20 are captured by the image obtaining device 3 or input from the external electronic device.

The object locating module 211 locates a specified object in an image using an object recognition method. In one embodiment, the specified object may contain sensitive information involving privacy, such as a human face, a license plate, or a doorplate. For example, if the specified object is the human face, the object locating module 211 locates a face using a skin color model in YCbCr space or a face template matching method. This embodiment takes YCbCr space as an example. In YCbCr, the Y is the brightness (luma), Cb is blue minus luma (B−Y), and Cr is red minus luma (R−Y). One example of an equation for finding facial skin is as follows.

$$P ( x , y ) = \{ \begin{matrix}1 , if [ 135 \leq Cr ( x , y ) \leq 156 ] ⋂ [ 108 \leq Cb ( x , y ) \leq 123 ] \\ 0 , otherwise\end{matrix}$$

In the equation, “P” stands for a pixel in the image, and “(x, y)” stands for a coordinate of “P”. In one embodiment, a value of Cr(x, y) ranges from 135 to 156, a value of Cb(x, y) ranges from 108 to 123. In other embodiments, the values of the Cr(x, y) and the Cb(x, y) may be any other suitable ranges. If a value of the P(x, y) is 1, the face locating module 211 judges that an examined area in the image is facial skin. If a value of the P(x, y) is 0, the face locating module 211 judges that an examined area in the image is not facial skin. If the examined area is facial skin, then the examined area in the image is set to white, otherwise, the examined area is set to black.

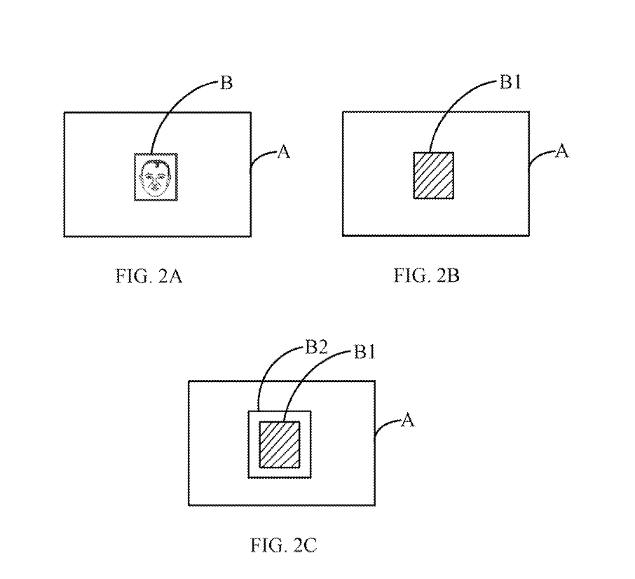

The calculating module 212 calculates a smallest rectangle framing the specified object (refers to FIG. 2A). In FIG. 2A, “A” stands for an image obtained from the storage device 20, “B” stands for the smallest rectangle framing a face of the image “A”.

The processing module 213 performs a masking operation on the smallest rectangle using a codec, so as to obtain a processed image (refers to FIG. 2B). In FIG. 2B, “B1” stands for the smallest rectangle framing the face of “A” after performing the masking operation on the smallest rectangle “B”. In one embodiment, the codec is an internal part of the image processing system 21. In other embodiments, the codec may be an external part of the image processing system 21.

In other embodiments, the processing module 213 may be further operable to perform the masking operation on an area edge of the smallest rectangle. For example, referring to FIG. 2C, “B2” stands for the area edge, which is a region having a width of 10 millimeters around the smallest rectangle “B1.”

The storing module 214 stores the processed image in the storage device 20.

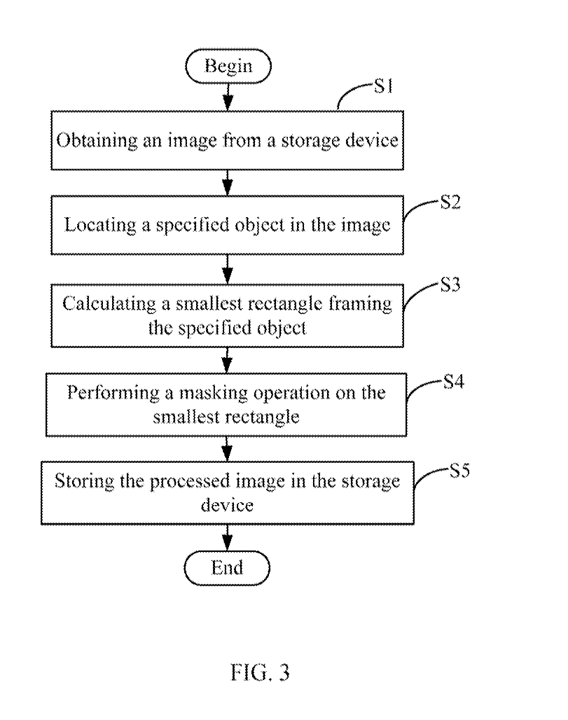

FIG. 3 is a flowchart of one embodiment of a method for processing images.

In block S1, the image obtaining module 210 obtains an image from the storage device 20. In one embodiment, the images stored in the storage device 20 are captured by the image obtaining device 3 or inputted from the external electronic device.

In block S2, the object locating module 211 locates a specified object in the image using an object recognition method. In one embodiment, the specified object may be a human face, a license plate, or a doorplate.

In block S3, the calculating module 212 calculates a smallest rectangle framing the specified object.

In block S4, the processing module 213 performs a masking operation on the smallest rectangle using a codec, so as to obtain a processed image. In other embodiments, the processing module 213 may be further operable to perform the masking operation on an area edge of the smallest rectangle.

In block S5, the storing module 214 stores the processed image in the storage device 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented image processing method, comprising:
obtaining an image from a storage device;
locating a specified object in the image;
calculating a smallest rectangle framing the specified object;
performing a masking operation on the smallest rectangle so as to obtain a processed image; and
storing the processed image in the storage device.

2. The method according to claim 1, wherein the image in the storage device is captured by an image obtaining device or input from an external electronic device.

3. The method according to claim 1, wherein the specified object is privacy-sensitive.

4. The method according to claim 1, wherein performing a masking operation on the smallest rectangle is achieved by using a codec.

5. The method according to claim 1, further comprising: performing the masking operation on an area edge of the smallest rectangle.

6. A storage medium having stored thereon instructions that, when executed by a processor of a computer, causes the processor to perform a method for processing images, the method comprising:
obtaining an image from a storage device;
locating a specified object in the image;
calculating a smallest rectangle framing the specified object;
performing a masking operation on the smallest rectangle so as to obtain a processed image; and
storing the processed image in the storage device.

7. The storage medium according to claim 6, wherein the image in the storage device is captured by an image obtaining device or input from an external electronic device.

8. The storage medium according to claim 6, wherein the specified object is privacy-sensitive.

9. The storage medium according to claim 6, wherein performing a masking operation on the smallest rectangle is achieved by using a codec.

10. The storage medium according to claim 6, further comprising: performing the masking operation on an area edge of the smallest rectangle.

11. The storage medium according to claim 6, wherein the medium is selected from the group consisting of a hard disk drive, a compact disc, a digital video disc, and a tape drive.

12. A computing system for processing images, comprising:
a storage device for storing images;
an image obtaining module operable to obtain an image from a storage device;
an object locating module operable to locate a specified object in the image;
a calculating module operable to calculate a smallest rectangle framing the specified object;
a processing module operable to perform a masking operation on the smallest rectangle, so as to obtain a processed image; and
a storing module operable to store the processed image in the storage device.

13. The system according to claim 12, wherein the image in the storage device is captured by an image obtaining device or input from an external electronic device.

14. The system according to claim 12, wherein the specified object is privacy-sensitive.

15. The system according to claim 12, wherein the processing module performs the masking operation on the smallest rectangle by using a codec.

16. The system according to claim 12, wherein the processing module further operable to perform the masking operation on an area edge of the smallest rectangle.
